(19) United States
(12) Patent Application Publication
(10) Pub. No.: US 2025/0360450 A1
(43) Pub. Date: Nov. 27, 2025

(54) APPARATUS AND METHOD FOR EXTRACTING CO2 FROM AIR

(71) Applicant: Purem GmbH, Neunkirchen (DE)

(72) Inventors: Heike Többen, Uhingen (DE); Dennis Felger, Esslingen (DE); Thomas Wolf, Esslingen (DE)

(21) Appl. No.: 19/217,980

(22) Filed: May 23, 2025

(30) Foreign Application Priority Data
May 24, 2024 (DE) 10 2024 114 583.8
Jul. 18, 2024 (DE) 10 2024 120 259.9

(51) Int. Cl. B01D 53/04

(52) U.S. Cl. CPC B01D 53/0438; B01D 2253/108; B01D 2253/20; B01D 2257/504; B01D 2258/06; B01D 2259/40096

(57) ABSTRACT

An apparatus extracting CO₂ from air includes an extraction reactor through which CO₂-containing air is able to flow in an adsorption mode and which has an adsorption surface. A heating assembly heats the at least one extraction reactor at least in the region of its adsorption surface to a temperature above an extracted gas desorption temperature in a heating/desorption mode. At least one extracted gas store stores CO₂ desorbed from the at least one extraction reactor in the heating/desorption mode. The extraction reactor includes at least one substrate having a multiplicity of flow-through cells or flow channels of a porous structure, the adsorption surface being formed on the substrate. The substrate is electrically conductive and heatable by application of a voltage. The heating assembly includes the at least one substrate and a voltage source for applying a voltage to the at least one substrate.

### CROSS-REFERENCE TO RELATED APPLICATIONS

This application claims priority of German patent application nos. 10 2024 114 583.8, filed May 24, 2024, and 10 2024 120 259.9, filed Jul. 18, 2024, the entire contents of which are incorporated herein by reference.

### TECHNICAL FIELD

The present disclosure relates to an apparatus and a method for extracting CO₂ from air.

### BACKGROUND

In order to prevent an excessive, climate-change-promoting increase in the level of CO₂ in the earth's atmosphere, extensive measures are being taken to reduce CO₂ emissions. However, these measures are not able to contribute to lowering the already existing level of CO₂, that is, to retrieving from the earth's atmosphere the CO₂ that is already present in it. An example of a known way of achieving this is to generate natural stores of extracted gas through extensive measures for reforestation or measures for renaturation of moors.

### SUMMARY

It is an object of the present disclosure to provide an apparatus and a method for extracting CO₂ from air, via which the removal of CO₂ from air is achieved reliably in a simple technical realization.

In a first aspect of the present disclosure, this object is achieved by an apparatus for extracting CO₂ from air, including:
at least one extraction reactor through which CO₂-containing air is able to flow in an adsorption mode and which has an adsorption surface,
a heating assembly for heating the at least one extraction reactor at least in the region of its adsorption surface to a temperature above an extracted gas desorption temperature in a heating/desorption mode,
at least one extracted gas store for storing CO₂ desorbed from the at least one extraction reactor in the heating/desorption mode,
the extraction reactor including at least one substrate having a multiplicity of flow-through cells or flow channels of a porous structure, the adsorption surface being formed on the at least one substrate, the at least one substrate being electrically conductive and being heatable by application of a voltage, the heating assembly including the at least one substrate and a voltage source for application of a voltage to the at least one substrate.

Since the heating assembly in the apparatus constructed according to the disclosure includes the substrate that is heatable by application of a voltage owing to its electrical resistance, the substrate with the CO₂ adsorbed thereon can be heated very rapidly to a sufficiently high temperature when the heating/desorption mode is initiated and, at this temperature, the CO₂ adsorbed on the adsorption surface is rapidly and substantially completely desorbed. The use of, for example, a gaseous heating medium requiring temporal separation of the heating mode and the desorption mode can be avoided, and the energy used for heating the substrate can be utilized for desorption of CO₂ essentially without any energy losses.

It should be noted that the present disclosure can be used particularly advantageously in the extraction of CO₂ (carbon dioxide) from the earth's atmosphere, that is, from air. However, the present disclosure can also be used in connection with other CO₂-containing gas mixtures. In this respect, air is to be regarded merely as an example or placeholder for such CO₂-containing gas mixtures. All aspects of the disclosure set out below can equally be used in apparatuses and methods via which CO₂ as extracted gas is extracted from CO₂-containing gas mixtures other than air.

Similarly, CO₂ as extracted gas is to be regarded only as an example or placeholder for any other gas which is present in a gas mixture and is to be extracted therefrom and which can be extracted from the gas mixture by adsorption and released again by subsequent desorption and conducted into an appropriate store. All aspects of the disclosure set out below can equally be used in apparatuses and methods via which extracted gases other than CO₂, for example water or steam, are extracted from air or other gas mixtures containing them.

For the treatment of large volumes of air, it is proposed that at least one, preferably each, extraction reactor include an extraction unit having a plurality of parallel substrates through which air is able to flow and which each have an adsorption surface.

The substrate may be made of, for example, monolithically formed SiC. SiC is a material which, firstly, is already used in other fields of application, for example in catalytic converters or particle filters for exhaust systems of internal combustion engines, for producing substrates having a multiplicity of cells through which gas is able to flow, and the industrial production of which is already well developed. Secondly, the behavior of SiC as regards electrical conduction is such that the application of a voltage to substrates made of such a material can lead to heating to a temperature of above 50° C., preferably in the range from 100° C. to 150° C., that is required in particular for desorption of CO₂.

Alternatively, the substrate may be made using:
titanium oxide, or
a metallic material, preferably a metal foam or metallic honeycomb structure.

To provide the adsorption surface, the substrate may be coated with an adsorption coating.

For efficient adsorption of CO₂, the adsorption coating may be made of zeolite or an organometallic material, for example MOF CALF-20. Such materials or organometallic lattice structures form a surface which has high selectivity, that is, pronounced adsorption behavior, with respect to the medium to be adsorbed, that is, for example CO₂.

In order to achieve flow of air through the at least one extraction reactor in the CO₂ adsorption mode, it is proposed that there be provided at least one gas mixture conveying assembly for conveying air through the at least one extraction reactor in the adsorption mode.

In order to ensure in the transition to the heating/desorption mode that only desorbed extracted gas, that is, for example CO₂, is conducted into the at least one extracted gas store, there may be provided at least one extraction reactor emptying pump for pumping air out of the at least one extraction reactor, preferably to the surroundings, in a gas mixture pump-out mode or/and for pumping CO₂ out of the at least one extraction reactor into the extracted gas store in the heating/desorption mode.

According to a further aspect, the object stated at the outset is achieved by a method for extracting CO₂ from air via an apparatus constructed according to the disclosure, including the measures of:
a) in the adsorption mode, conveying air through the at least one extraction reactor and adsorbing CO₂ on the adsorption surface of the at least one extraction reactor,
b) in the heating/desorption mode following the adsorption mode, heating the at least one extraction reactor at least in the region of its adsorption surface to a temperature above an extracted gas desorption temperature by application of a voltage to the substrate of the at least one extraction reactor and conducting CO₂ desorbed from the at least one extraction reactor to the at least one extracted gas store.

As a result of the alternating adsorption and desorption of CO₂ in one or more extraction reactors and the supply of the desorbed extracted gas, that is, in particular CO₂, to one or more extracted gas stores, CO₂ can be removed from the earth's atmosphere in a clocked operation, stored and optionally further used in chemical processes or further used directly, for example as welding gas.

In order to ensure that, in the heating/desorption mode, a highest possible concentration of desorbed CO₂ is conducted to the at least one extracted gas store, it is proposed that, after the end of the adsorption mode and before the start of the heating/desorption mode, air present in the at least one extraction reactor be pumped out as residual gas atmosphere in a gas mixture pump-out mode.

### BRIEF DESCRIPTION OF DRAWINGS

The invention will now be described with reference to the drawings wherein:

FIG. 1 is a schematic of an apparatus for extracting CO₂ from air;

FIG. 2 is a schematic section view of an extraction reactor of the apparatus of FIG. 1;

FIG. 3 shows a cross-sectional view of a substrate coated with an adsorption coating;

FIG. 4 shows a cross-sectional view of an extraction unit having a plurality of substrates coated with an adsorption coating; and,

FIG. 5 shows a cross-sectional view of an extraction unit of an alternative configuration, the view corresponding to FIG. 4.

### DETAILED DESCRIPTION

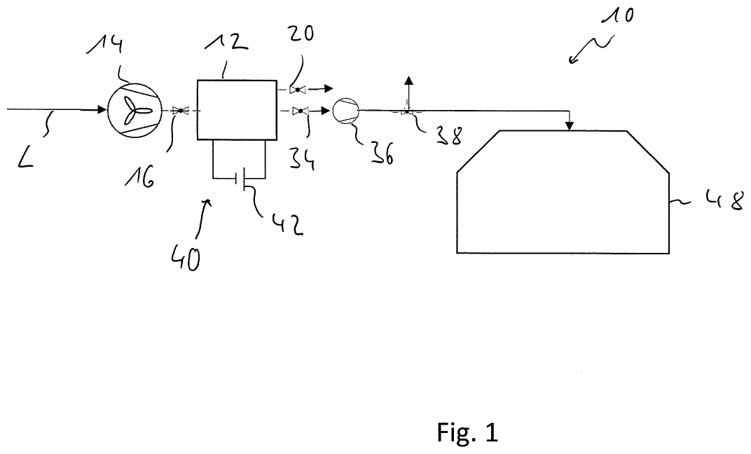

In FIG. 1, an apparatus for extracting CO₂ from air is identified generally by 10. The DAC (direct air capture) apparatus 10 includes an extraction reactor 12 into which, in an adsorption mode, air L as gas mixture is conveyed by a gas mixture conveying assembly 14 in the form of a fan or compressor or the like. In the adsorption mode, a shutoff valve 16 upstream of the extraction reactor 12 is in its release position, such that the air L can flow through the extraction reactor 12 and can exit the extraction reactor back to the surroundings via a gas mixture discharge line 18, that is, via a shutoff valve 20 disposed therein.

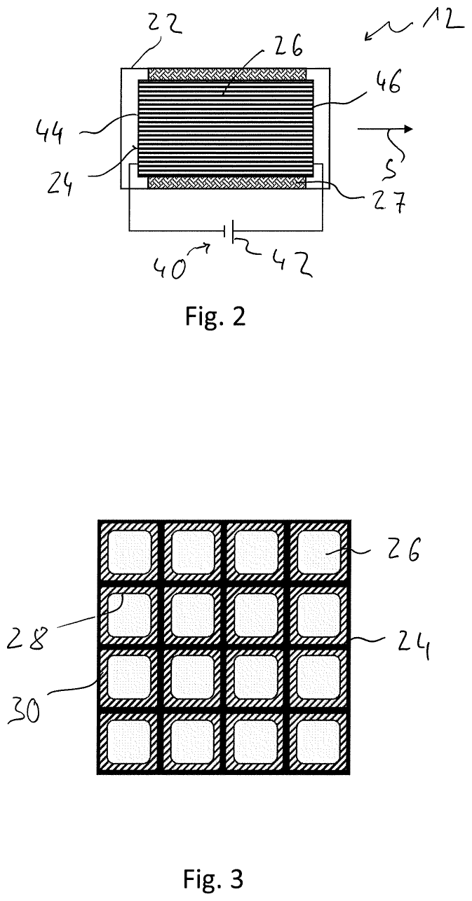

The extraction reactor 12 shown in longitudinal section in a schematic illustration in FIG. 2 includes in a, for example, tubular-like housing 22, a substrate 24 having a multiplicity of channel-type cells 26 extending therein in an air flow direction S. The substrate 24 is supported in the housing 22 by a support assembly 27 made of, for example, a fibrous material.

FIG. 3 shows, by way of example, a cross section of the substrate 24 which, in the example shown, has a square outer peripheral contour, but may equally have a cross-sectional contour that is round or some other shape. The substrate 24 made of an electrically conductive material, preferably SiC (silicon carbide), includes the cells 26 at a density of, for example, 40 cpsi (cells per square inch) to 750 cpsi and, in the case of a circular outer peripheral contour, may have a diameter of up to 13 inches, that is, 32 cm to 33 cm, or, in the case of the square configuration shown, may have an edge length of 10 cm to 30 cm. In an alternative embodiment, the substrate 24 may be made of, for example, titanium oxide or a metallic material, for example in the form of a metallic honeycomb structure or in the form of an open-cell metal foam, which provides a multiplicity of flow channels. For such substrates made of a metallic material, a metallic material which is customarily also used for heating conductors may be used. For example, nickel-copper alloys or nickel-chromium alloys may be used.

The surface of the substrate 24 encircling the cells 26 is coated with an adsorption coating 30 providing an adsorption surface 28. For example, the material used for such a coating may be zeolite or an organometallic material or an organometallic lattice structure such as MOF CALF-20, that is, a material having high selectivity, that is, a very good adsorption capacity, with respect to the material to be adsorbed, for example CO₂. The high cell density provides a large surface area at a comparatively low flow resistance, the CO₂ in the air being adsorbed on the surface area in the adsorption mode, thereby allowing extraction thereof from the air. The air, which is ideally completely depleted of CO₂, leaves the extraction reactor 12 via the gas mixture discharge line 18 in the adsorption mode.

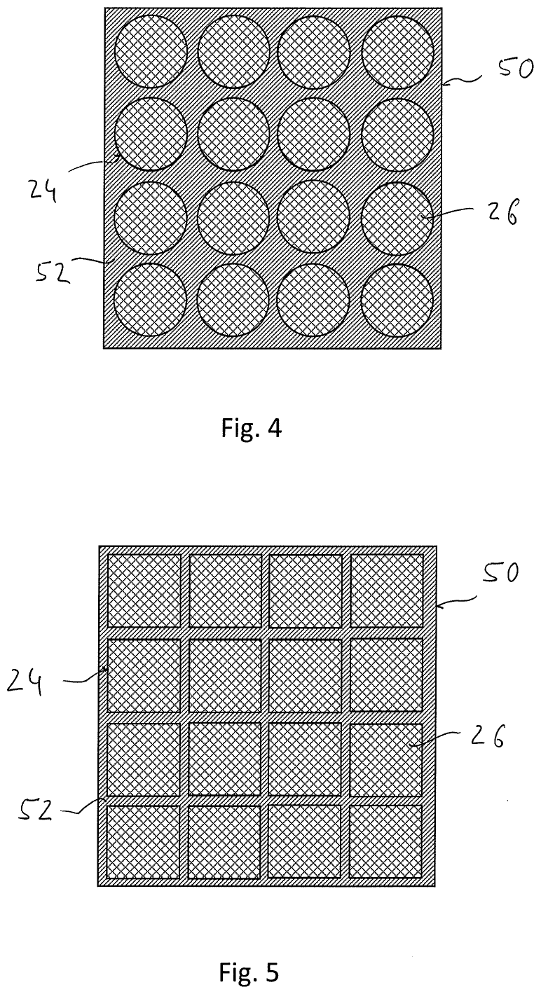

FIGS. 4 and 5 show different embodiments of extraction units 50, each of which includes a plurality of the substrates 24 coated with an adsorption coating 30. Each extraction unit 50 includes a carrier structure 52 in which a multiplicity of the substrates 24 is supported. The support structure 52 made of, for example, plastics material or metallic material may be a structure through which gas is not able to flow, such that the entire gas mixture introduced into the extraction reactor 12 flows through the cells 26 or the flow channels of the substrates 24.

In the embodiment of the extraction unit 50 shown in FIG. 4, the substrates 24 have a circular cross section and are arranged in a square pattern, yielding mutually parallel rows and columns of substrates 24 which are substantially non-staggered with respect to one another. In the case of a structure contributing to a relatively high density of the substrates 24, the substrates 24 of adjacent columns or rows may be staggered with respect to one another, producing an arrangement in the manner of a highly dense sphere packing.

FIG. 5 shows an arrangement of substrates 24 having a square cross section in the extraction unit 50. Here too, the substrates 24 are arranged relative to one another in a square pattern, yielding mutually parallel columns and rows of substrates 24 substantially non-staggered with respect to one another.

In principle, the substrates 24 may also have other cross-sectional geometries, for example a hexagonal or octagonal cross-sectional geometry, in order to allow a densest possible arrangement thereof in such an extraction unit 50.

The use of the extraction units 50 in the extraction reactor 12 makes it possible, in the case of such DAC apparatuses 10 of generally stationary operation, to conduct large volume flows of the gas mixture, that is, for example air, through the extraction reactor 12 and thus also to provide correspondingly large surface areas for treatment of the gas mixture or for extraction of the gas to be extracted, that is, for example CO₂.

After the end of the adsorption mode, the CO₂ adsorption reactor 12 is first completely closed to prevent air L from flowing through. This is accomplished by bringing the two shutoff valves 16, 20 into their shutoff position. This is followed by opening a shutoff valve 34 disposed in an emptying line 32 and starting operation of an extraction reactor emptying pump 36 in order to pump out of the extraction reactor 12 the gas mixture, that is, air, still present therein and thus generate a negative pressure in the extraction reactor 12. The air pumped out of the extraction reactor 12 in the gas mixture pump-out mode can be emitted into the surroundings via a directional valve 38.

After the air has been pumped out of the extraction reactor 12, a heating assembly 40 is activated, via which the substrate 24 or the adsorption coating 30 provided thereon is brought to such a temperature that the CO₂ adsorbed thereon is desorbed. The heating assembly 40 includes the substrate 24 made of an electrically conductive material, that is, for example SiC, and a voltage source 42 schematically illustrated in FIGS. 1 and 2, that is, for example a battery or a DC voltage grid or the like. The voltage generated by the voltage source 42 can be applied to the two end faces 44, 46 of the substrate 26 that are spaced from one another in the air flow direction S or the direction of extent of the channel-type cells 26. In order to ensure a uniform current flow through the entire cross section of the substrate 24, the end faces 44, 46 of the substrate 24 may be coated with an electrode coating made of, for example, metal.

As a result of the application of a voltage, the substrate 24 heats up to a temperature above the desorption temperature owing to the electric current flow, such that the CO₂ adsorbed on the adsorption surface 28 is desorbed under applied voltage and thus continued heating.

To discharge the desorbed extracted gas CO₂, the extraction reactor emptying pump 36 is activated with the shutoff valve 34 set in its release position. Furthermore, the directional valve 38 is set such that the CO₂ pumped out of the extraction reactor 12 is conveyed not to the surroundings, but into an extracted gas store 48 in which the CO₂ extracted from the air can be stored, for example at a store pressure of about 50 bar and at ambient temperature.

To end the heating/desorption mode, the application of a voltage to the substrate 24 is ended. The operation of the extraction reactor emptying pump 36 is ended too, and the shutoff valve 34 is brought into its shutoff position. In order then to restart the adsorption mode, the two shutoff valves 16, 18 are brought into their release position and operation of the gas mixture conveying assembly 14 is started in order to reconduct CO₂-containing air, that is, a gas mixture containing a gas to be extracted, through the extraction reactor 12 or the cells 26 of the substrate 24 thereof and, at the same time, to adsorb CO₂ present in the air on the adsorption surface 28.

The different operating modes adsorption mode and heating/desorption mode may each be carried out over fixed time periods associated therewith. It is also possible, with use of appropriate open-loop or closed-loop control technologies and with use of sensors providing information representing the different gas concentrations or gas compositions, to initiate or end the respective process steps when gas concentrations fall below or exceed defined thresholds.

Finally, it should be noted that the apparatus 10 may be varied in various aspects. For example, a plurality of such extraction reactors may be provided that can be operated in the adsorption mode and in the heating/desorption mode either synchronously or alternately. For example, one extraction reactor or a portion of the extraction reactors may be operated in the adsorption mode, while another extraction reactor or another portion of the extraction reactors is operated in the heating/desorption mode. All the extraction reactors may be fed, for example, from the same voltage source, such that the heating assemblies associated with the different extraction reactors can be linked to one another via a common voltage source. Depending on which of the extraction reactors is to be operated in the heating/desorption mode, the voltage provided by the voltage source can then be applied to the substrate thereof by closing corresponding circuits.

It is understood that the foregoing description is that of the preferred embodiments of the invention and that various changes and modifications may be made thereto without departing from the spirit and scope of the invention as defined in the appended claims.

1. An apparatus for extracting CO₂ from air, the apparatus comprising:
at least one extraction reactor being throughflowable by CO₂-containing air in an adsorption mode and having an adsorption surface;
a heating assembly for heating said at least one extraction reactor at least in a region of said adsorption surface to a temperature above an extracted gas desorption temperature in a heating/desorption mode;
at least one extracted gas store for storing CO₂ desorbed from said at least one extraction reactor in the heating/desorption mode;
said extraction reactor including at least one substrate having a multiplicity of flow-through cells or flow channels of a porous structure;
said adsorption surface being formed on said at least one substrate;
said at least one substrate being electrically conductive and being heatable by application of a voltage; and,
said heating assembly including said at least one substrate and a voltage source for applying a voltage to said at least one substrate.

2. The apparatus of claim 1, wherein said at least one extraction reactor comprises an extraction unit having a plurality of parallel substrates wherethrough air is flowable and each substrate having an adsorption surface.

3. The apparatus of claim 1, wherein said at least one substrate is made of one of the following: SiC; titanium oxide; a metallic material; a metal foam; and, a metallic honeycomb structure.

4. The apparatus of claim 1, wherein said at least one substrate is coated with an adsorption coating providing said adsorption surface.

5. The apparatus of claim 4, wherein said adsorption coating is made of: zeolite, or an organometallic material.

6. The apparatus of claim 1, further comprising at least one gas mixture conveying assembly for conveying air through said at least one extraction reactor in the adsorption mode.

7. The apparatus of claim 1, further comprising at least one extraction reactor emptying pump for pumping air out of said at least one extraction reactor in at least one of: i) in a gas mixture pump-out mode; and ii) for pumping CO₂ out of said at least one extraction reactor into said extracted gas store in said heating/desorption mode.

8. The apparatus of claim 1, further comprising at least one extraction reactor emptying pump for pumping air out of said at least one extraction reactor to the surroundings, in at least one of: i) in a gas mixture pump-out mode; and ii) for pumping CO₂ out of said at least one extraction reactor into said extracted gas store in said heating/desorption mode.

9. A method for extracting CO₂ from air via an apparatus for extracting CO₂ from air, the apparatus including: at least one extraction reactor being throughflowable by CO₂-containing air in an adsorption mode and having an adsorption surface; a heating assembly for heating said at least one extraction reactor at least in a region of said adsorption surface to a temperature above an extracted gas desorption temperature in a heating/desorption mode; at least one extracted gas store for storing CO₂ desorbed from said at least one extraction reactor in the heating/desorption mode; said extraction reactor including at least one substrate having a multiplicity of flow-through cells or flow channels of a porous structure; said adsorption surface being formed on said at least one substrate; said at least one substrate being electrically conductive and being heatable by application of a voltage; and, said heating assembly including said at least one substrate and a voltage source for applying a voltage to said at least one substrate; the method including the steps of:
a) in the adsorption mode, conveying air through the at least one extraction reactor and adsorbing CO₂ on the adsorption surface of the at least one extraction reactor; and,
b) in the heating/desorption mode following the adsorption mode, heating the at least one extraction reactor at least in the region of the adsorption surface thereof to a temperature above an extracted gas desorption temperature by applying a voltage to the at least one substrate of the at least one extraction reactor and conducting the CO₂ desorbed from the at least one extraction reactor to the at least one extracted gas store.

10. The method of claim 9, wherein, after the end of the adsorption mode and before the start of the heating/desorption mode, air present in the at least one extraction reactor is pumped out in a gas mixture pump-out mode.
